(19) United States
(12) Patent Application Publication
(10) Pub. No.: US 2006/0007517 A1
(43) Pub. Date: Jan. 12, 2006

(54) Structure of a micro electro mechanical system

(75) Inventor: Hsiung-Kuang Tsai, Taipei City (TW)

Correspondence Address: GRIFFIN & SZIPL, PC, SUITE PH-1, 2300 NINTH STREET, SOUTH, ARLINGTON, VA, 22204, US

(73) Assignee: Prime View International Co., Ltd., Hsinchu (TW)

(21) Appl. No.: 10/960,927

(22) Filed: Oct. 12, 2004

(30) Foreign Application Priority Data
Jul. 9, 2004 (TW) 93120662

(51) Int. Cl. G02F 1/03

(52) U.S. Cl. 359/254

(57) ABSTRACT

A structure of a micro electro mechanical system (MEMS) for a planar display apparatus is described. The MEMS structure used as a transmissible or reflective display device has a shielding electrode and a control electrode. The shielding electrode has a low stress electrode and a high stress electrode. The high stress electrode connected to the low stress electrode is a movable element. The control electrode is located below the high stress electrode. The control electrode attracts the high stress electrode when a voltage is applied to the control electrode. The high stress electrode deforms and the position of the low stress electrode is altered.

### RELATED APPLICATIONS

The present application is based on, and claims priority from, Taiwan Application Serial Number 93120662, filed Jul. 9, 2004, the disclosure of which is hereby incorporated by reference herein in its entirety.

### FIELD OF THE INVENTION

The present invention relates to a micro electro mechanical system for a transmissible or reflective display unit structure, and more particularly, to a transmissible or reflective display unit structure suitable for use in a planar display apparatus.

### BACKGROUND OF THE INVENTION

Since a planar display apparatus is small and lightweight, it has predominance in the portable display device and small-volume display markets. At present, the mainstream planar display apparatus is the liquid crystal display (LCD).

Most liquid crystal displays at present turn each crystal molecule on and off by the twisting and rearranging of the crystal molecules in the electric field. However, since the conventional liquid crystal display uses polarized light to twist the crystal molecule, the view angle of the thin film transistor liquid crystal display is narrow. Thus, when the liquid crystal display is viewed from the side, the contrast may be lowered and further, the image inverted. Therefore, in order to solve the problem of the small view angle, several methods have been suggested to produce a monitor with a wide view angle. One of them is the alignment method of forming two or more alignment layers with different directions on the pixel electrode in each liquid crystal display.

However, the process steps in the aforementioned method are complicated. For example, in the aforementioned alignment method, two steps of rubbing are necessary for alignment, and the differentiation of the pixel electrode into two parts requires a plurality of process steps. The difficulty of process is thus increased. In recent years, an optically compensated bend (OCB) liquid crystal molecule is used to replace the conventional twisted nematic liquid crystal molecule in forming liquid crystal displays. The optical compensation of the liquid crystal molecule compensates for the birefringence of the liquid crystal molecule to provide a wide view angle, and alignment processes with different directions are not needed.

However, in an optically compensated bend liquid crystal display, the liquid crystal molecule are oblique without an external electric field, and will be bent with external high voltage. Therefore, when using the optically compensated bend liquid crystal display, the oblique mode needs to be changed to the bent mode by external high voltage in the beginning. However, the step is time-consuming, and thus cannot achieve a fast response.

In the final analysis, the key point is the property of the liquid crystal molecule. If the liquid crystal molecule is used as the switch to control the penetration of the light, it is hard to avoid the aforementioned problem.

### SUMMARY OF THE INVENTION

Hence, an objective of the present invention is to provide a micro electro mechanical system (MEMS) to be used as a transmissible display unit, which may replace conventional liquid crystal molecules and serve as a switch to control the penetration of the light through the planar display apparatus.

Another objective of the present invention is to provide a micro electro mechanical system to be used as a transmissible display unit, which is set in front of the back light source and controls the penetration of light and the amount thereof to further control different transmissible display units to produce gray scales.

Still another objective of the present invention is to provide a micro electro mechanical system to be used as a reflective display unit, which is set in front of the reflective elements to shield the reflective elements and controls the reflection of incident light and the amount of reflected incident light to control further different reflective display units to produce gray scales.

Still another objective of the present invention is to provide a micro electro mechanical system to be used as a reflective display unit, which may be used as a light-reflecting layer or a light-absorbing layer to control the reflection of incident light.

According to the aforementioned objectives, the present invention provides a micro electro mechanical system to be used as a transmissible display unit. The micro electro mechanical system comprises an upper electrode and a lower electrode, in which the upper electrode is a shielding electrode and the lower electrode is a control electrode. The upper electrode and the lower electrode are located on a transparent substrate. The upper electrode is composed of two kinds of material with different stresses. One is a low stress structure used as a shielding electrode, and the other is a high stress structure connecting to one side of the low stress structure. The high stress structure drives the low stress structure to rotate along a substantial or virtual axis. This affects the shielding effect of the light source therebelow to different extents. The lower electrode is located below the high (low) stress structure. After supplying different voltages to the lower electrode, the high stress structure will have a different deformation and make the low stress structure rotate to provide a different shielding effect. Generally speaking, the material of the lower electrode is a conductor or a semiconductor material, such as metal, silicide, doped polysilicon and metal oxide, or a transparent conductor material, such as indium-tin oxide, indium oxide and tin oxide. The high stress structure of the upper electrode is, for example, chromium, chromium alloy, nickel, titanium or any arbitrary combination thereof. The low stress structure of the upper electrode is metal or semiconductor material, such as silver, aluminum, copper, molybdenum, silicon or any arbitrary combination thereof. A light-absorbing material may be further formed on the lower surface of the low stress material. When the low stress material shields the light source, the light-absorbing material absorbs the light and reduces light leakage. The light-absorbing material is, for example, black resin or metal with a low reflectivity or metal oxide with a low reflectivity, such as chromium or chromium oxide.

When the voltage applied to the lower electrode is removed, the high stress structure recovers to the curved state and the low stress structure stands, so the light source below may penetrate thoroughly. Since the transmissible display units provided by the present invention are not restricted to the usage of the polarized light as conventional liquid crystal molecules are, there is no restriction in view angle. Further, the micro electro mechanical system provided by the present invention does not need to use the polarized light produced from the two polarizers above or below the liquid crystal molecule as the conventional liquid crystal molecule does, so polarizers are not needed above or below, and the efficiency of the usage of light may be greatly increased.

In addition to using the location of the high stress structure to control the change of the gray scale to produce a black-and-white planar display apparatus, a planar multicolor display apparatus can be produced by setting color filters between the light source and the transmissible display unit or above the transmissible display unit.

From the above, the transmissible display units provided by the present invention solves the problem of the restriction of the view angle of the conventional liquid crystal display, and provides greater brightness. Additionally, the transmissible display units provided by the present invention can replace the conventional liquid crystal molecule to produce a black-and-white or color planar display apparatus.

According to the aforementioned objectives, the present invention provides a micro electro mechanical system to be used as a reflective display unit. The micro electro mechanical system comprises an upper electrode and a lower electrode, in which the upper electrode is a shielding electrode and the lower electrode is a control electrode. The upper electrode and the lower electrode are located on a substrate. The substrate is, for example, a transparent substrate, a light-absorbing substrate, or a light-reflecting substrate. Generally speaking, the transparent substrate is more often used. The upper electrode comprises a deflective part and a shielding part. The deflective part and the shielding part may be formed of different materials, such as two structures with different stress, or formed of the same material. If it is formed of two structures with different stress, one is a low stress structure, and the other is a high stress structure connecting to one side of the low stress structure. The high stress structure drives the low stress structure to rotate along a substantial or virtual axis. This affects the shielding effect of the light-reflecting layer below to different extents. If it is formed of the same material, then the high stress material is used. The lower electrode can be located below the high (low) stress structure. After supplying different voltages to the lower electrode, the high stress structure will have a different deformation and make the low stress structure rotate to provide different shielding effects. Generally speaking, the material of the lower electrode is, for example, a conductor or semiconductor material, such as metal, silicide, doped polysilicon or metal oxide, or a transparent conductor material, such as indium-tin oxide, indium oxide or tin oxide. The high stress structure of the upper electrode is, for example, chromium, chromium alloy, nickel, titanium or any arbitrary combination thereof. The low stress structure of the upper electrode is metal or semiconductor material, such as silver, aluminum, copper, molybdenum, silicon or any arbitrary combination thereof. A light-absorbing material can be further formed on the upper surface of the low stress material. When the low stress material shields the light-reflecting layer, the light-absorbing material absorbs the light and reduces light leakage. The light-absorbing material may be black resin or metal with low reflectivity or metal oxide with low reflectivity, such as chromium and chromium oxide.

When the voltage applied to the lower electrode is removed, the high stress structure recovers to the curved state and the low stress structure stands, so the light-reflecting layer below reflects the incident light.

In addition to using the location of the high stress structure to control the change of the gray scale to produce a black and white planar display apparatus, a color planar display apparatus can be produced by setting color filters between the light source and the reflective display unit or above the reflective display unit.

The upper electrode as well as the light-reflecting layer can be used to form the light-reflecting layer. The micro electro mechanical system is formed on a light-absorbing layer. A reflecting surface is formed on the upper surface of the low stress structure of the upper electrode. When a voltage is applied, the high stress structure deforms and drives the low stress structure to rotate and makes the low stress structure cover the light-absorbing layer. The incident light is reflected by the reflection of the metal of the low stress structure or by an additional light-reflecting layer formed on the upper surface. When the voltage applied to the lower electrode is removed, the high stress structure recovers to the curved state and the low stress structure stands, so the light-absorbing layer below may absorb the incident light. A light-absorbing material can be further formed on the lower surface of the low stress structure. When the low stress structure stands, the light-absorbing material absorbs the light and decreases the effect of light leakage due to back reflecting. The light-absorbing material can be the same or different from the material of the light-absorbing layer. The light-absorbing material can be resin or metal with a low reflectivity or metal oxide with a low reflectivity.

The setting of the light-reflecting layer or the light-absorbing layer below the transparent substrate is because the ability of the transparent substrate to reflect and absorb the visible light is weak. Hence, the structure of the light-reflecting layer/transparent substrate or the light-absorbing layer/transparent substrate is replaced with a light-reflecting or light-absorbing substrate to simplify the composition structure of the reflective display units.

Since the reflective display units provided by the present invention are not restricted to the usage of the polarized light as conventional liquid crystal molecules are, there is no restriction in view angle. Further, the micro electro mechanical system provided by the present invention does not need to use the polarized light produced from the two polarizers above or below the liquid crystal molecule as the conventional liquid crystal molecule does, so polarizers are not needed above or below, and the efficiency of the usage of light is greatly increased.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional diagram of the display unit of a micro electro mechanical system provided by the present invention;

FIG. 2 is a cross-sectional diagram of the display unit of a micro electro mechanical system provided by the present invention;

FIG. 3 illustrates an application of transmissible display units disclosed by the present invention on a multicolor planar display apparatus;

FIG. 4 illustrates another embodiment of the application of transmissible display units disclosed by the present invention on a multicolor planar display apparatus;

FIG. 5 is a cross-sectional diagram of the reflecting display unit provided by the present invention; and

FIG. 6 is a cross-sectional diagram of another reflecting display unit provided by the present invention.

### DETAILED DESCRIPTION OF THE PREFERRED EMBODIMENT

In order to make clear the display unit of a micro electro mechanical system provided by the present invention, the structure of the transmissible display units disclosed in the present invention is described in detail in the preferred embodiments.

### Embodiment 1

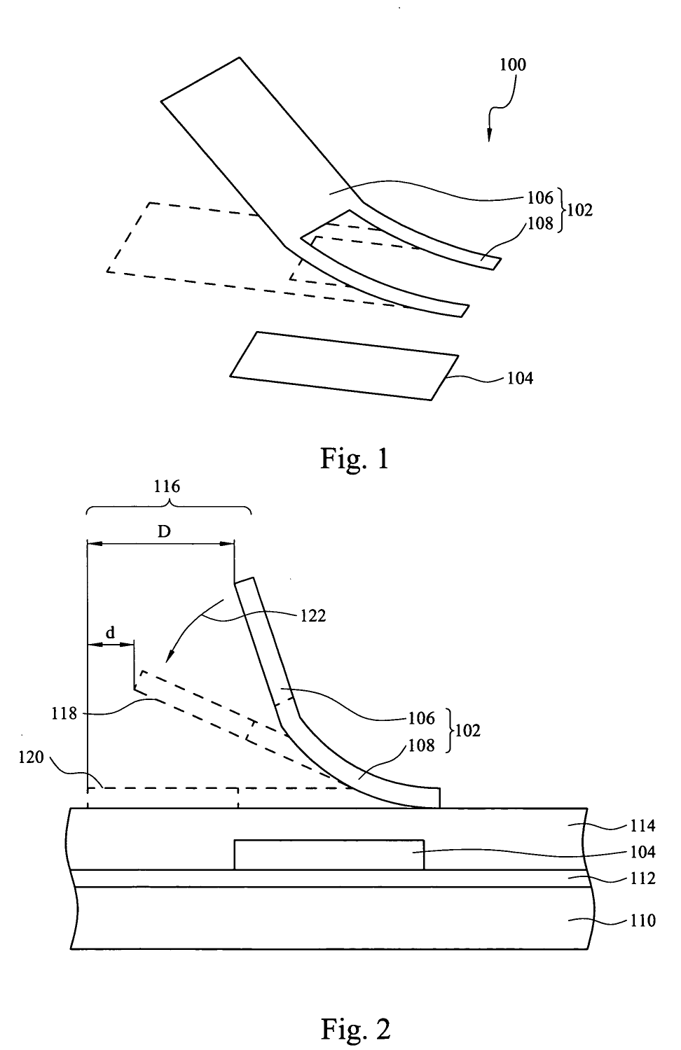

Reference is made to FIG. 1, which is a three-dimensional diagram of the display unit of a micro electro mechanical system provided by the present invention. The display unit of a micro electro mechanical system 100 includes an upper electrode 102 and a lower electrode 104, in which the upper electrode 102 and the lower electrode 104 are located on a transparent substrate (not shown in the drawing). The upper electrode 102 is composed of two kinds of material having different stress. One is a low stress structure 106 used as a shielding electrode, and the other is a high stress structure 108 connecting to one side of the low stress structure 106. The high stress structure 108 drives the low stress structure 106 to rotate along a substantial or virtual axis (not shown in the drawing). This will affect the shielding effect of the light source below the lower electrode 104 (not shown in the drawing) to different extents. The lower electrode 104 is located below the high stress structure 108. After supplying different voltages to the lower electrode 104, the high stress structure 108 has a different deformation and drives the low stress structure 106 to rotate to achieve a different extent of shielding. The dotted line denotes the location of the upper electrode 102 after the voltage is supplied to the lower electrode 104.

### Embodiment 2

Reference is made to FIG. 2, which is a cross-sectional diagram of the display unit of a micro electro mechanical system provided by the present invention. A lower electrode 104 is located on a transparent substrate 110. At least a dielectric layer 112 is located between the lower electrode 104 and the transparent substrate 110. A dielectric layer 114 is located on the lower electrode 104 as an insulating layer. A light-penetrating area 116 is located on the left side of the lower electrode 104. When used in transmissible display units, the light from the light source below the transparent substrate 110 (not shown in the drawing) penetrates through the area and is seen by viewers.

An upper electrode 102 is located on the dielectric layer 114. The upper electrode 102 comprises a low stress structure 106 and a high stress structure 108, in which the high stress structure 108 is connected to one side of the low stress structure 106. The high stress structure 108 is located above the lower electrode 104 and the low stress structure 106 is located above the light-penetrating area 116.

When no voltage is supplied to the lower electrode 104, the high stress structure 108 curves due to its high stress, and the low stress structure 106 is raised up by the high stress structure 108. When voltage is supplied to the lower electrode 104 and the upper electrode 102, the high stress structure 108 will rotate downward due to the attraction of the lower electrode 104, and drive the low stress structure 106 to rotate in the direction indicated by arrow 122. The displacement of the upper electrode 102 can be controlled by the voltage supplied to the lower electrode 104 and the upper electrode 102. This will change the shielding effect of the light source below the lower electrode 104 (not shown in the drawing) to different extents. For example, when the upper electrode 102 is located in the place denoted by the full line in FIG. 2, the low stress structure 106 shields the light-penetrating area 116 lightly and forms an opening with a distance D. When the upper electrode 102 is located at the place denoted by the dotted line 118 in FIG. 2, the low stress structure 106 shields part of the light-penetrating area 116 and forms an opening with a distance d. When the upper electrode 102 is located at the place denoted by the dotted line 120 in FIG. 2, the low stress structure 106 fully shields the light-penetrating area 116 and the light below the lower electrode 104 cannot penetrate through the light-penetrating area 116. The size of the opening can be controlled by controlling the voltage supplied to the lower electrode 104 and the upper electrode 102. Then, the amount of the light penetrating through the light-penetrating area 116 can be controlled and form gray scales.

The lower electrode 104 is a control electrode. The material of the lower electrode 104 can be a conductor material, such as metal, silicide, doped polysilicon and metal oxide, or a transparent conductor material, such as indium-tin oxide, indium oxide and tin oxide. If the lower electrode 104 is formed by metal, silicide, or doped polysilicon, there is an additional advantage; that is, since these materials are opaque, the lower electrode 104 can be used as a shielding layer to prevent light leakage.

### Embodiment 3

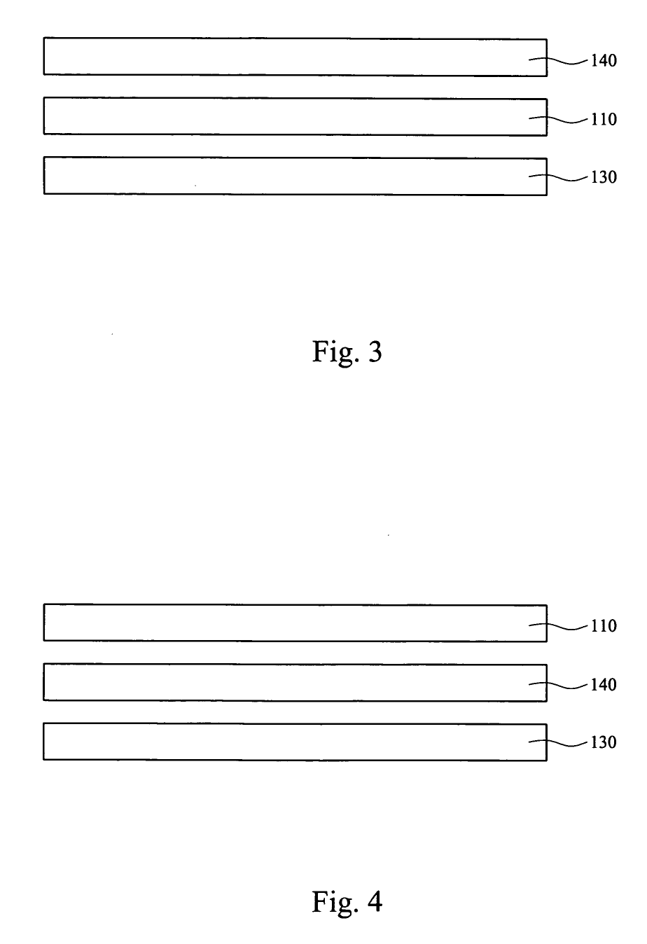

Reference is made to FIG. 3 illustrating the application of transmissible display units disclosed by the present invention on a multicolor planar display apparatus. A transparent substrate 110 having transmissible display units is put between a back light source 130 and a color filter 140. The transparent substrate 110 having transmissible display units can replace conventional liquid crystal molecules and serve as a switch to control the light penetrating through the planar display apparatus. FIG. 4 illustrates another embodiment of the application of transmissible display units disclosed by the present invention on a multicolor planar display apparatus. The color filter 140 is placed between the transparent substrate 110 having transmissible display units and the back light source 130. The transparent substrate 110 having transmissible display units can still replace conventional liquid crystal molecules and serve as a switch to control the light penetrating through the planar display apparatus. Additional polarizers are not needed above or below the transparent substrate 110 having transmissible display units. This will substantially increase the light utility rate of the back light source 130. Additionally, since the light that penetrates is omnibearing, there will be no restrictions for the viewers on the opposite side of the back light source 130.

### Embodiment 4

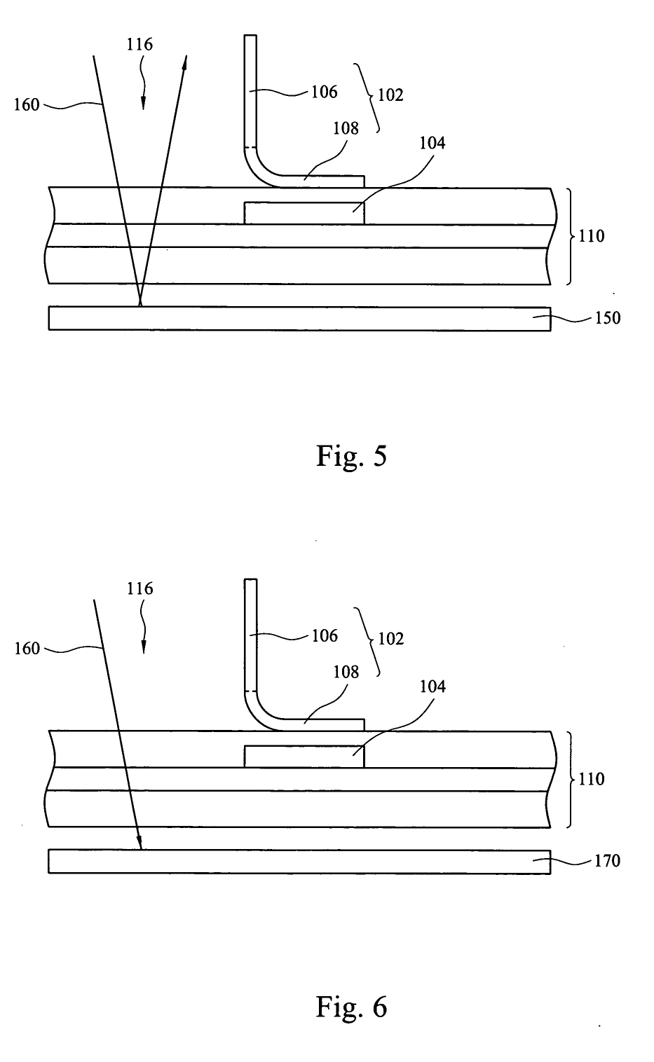

Reference is made to FIG. 5, which is a cross-sectional diagram of the reflecting display unit provided by the present invention. A transparent substrate 110 having display units 100 of a micro electro mechanical system is put on a light-reflecting plate 150. The transparent substrate 110 having display units 100 of a micro electro mechanical system can replace conventional liquid crystal molecules and serve as a switch to control the light penetrating through the planar display apparatus. When no voltage is supplied to the lower electrode 104 and the upper electrode 102, a high stress structure 108 curves, and a low stress structure 106 is raised up by the high stress structure 108. The incident light 160 is reflected by the light-reflecting plate 150. When voltage is supplied to the lower electrode 104 and the upper electrode 102, the high stress structure 108 will rotate downward due to the attraction of the lower electrode 104, and drive the low stress structure 106 to shield the light-reflecting plate 150 located below. The low stress structure 106 further comprises a light-absorbing layer (not shown in the drawing) to absorb the incident light so that no light can be seen by viewers.

The structure of the transparent substrate 110 and the light-reflecting plate 150 can be replaced by a light-reflecting substrate (not shown in the drawing).

### Embodiment 5

Reference is made to FIG. 6, which is a cross-sectional diagram of another reflecting display unit provided by the present invention. A transparent substrate 110 having display units 100 of a micro electro mechanical system is put on a light-absorbing plate 170. The transparent substrate 110 having display units 100 of a micro electro mechanical system can replace conventional liquid crystal molecules and serve as a switch to control the light penetrating through the planar display apparatus. When no voltage is supplied to the lower electrode 104 and the upper electrode 102, a high stress structure 108 curves, and a low stress structure 106 is raised up by the high stress structure 108. The incident light 160 is absorbed by the light-absorbing plate 170 so that no light can be seen by viewers. When voltage is supplied to the lower electrode 104 and the upper electrode 102, the high stress structure 108 will rotate downward due to the attraction of the lower electrode 104, and drive the low stress structure 106 to shield the light-absorbing plate 170 located below. The low stress structure 106 further comprises a light-reflecting layer (not shown in the drawing) to reflect the incident light to be seen by viewers.

The structure of the transparent substrate 110 and the light-absorbing plate 170 can be replaced by a light-absorbing substrate (not shown in the drawing).

Similarly, the reflecting display unit disclosed in the embodiment 4 and embodiment 5 can also combine color filters to form a color planar display apparatus. The transparent substrate 110 having reflective display units 100 can still replace conventional liquid crystal molecules and serve as a switch to control the light penetrating through the planar display apparatus. Additional polarizers are not needed above or below the transparent substrate 110 having reflective display units. This will substantially increase the light utility rate of the incident light. Further, since the light that penetrates is omnibearing, there will be no restrictions in the angle of view for the viewers.

As is understood by a person skilled in the art, the foregoing preferred embodiments of the present invention are illustrative of the present invention rather than limiting of the present invention. It is intended that various modifications and similar arrangements are covered within the spirit and scope of the appended claims, the scope of which should be accorded the broadest interpretation so as to encompass all such modifications and similar structures.

What is claimed is:

1. A display unit of a micro electro mechanical system, located on a substrate, the display unit of the micro electro mechanical system comprising:
an upper electrode, the upper electrode comprising:
a deflective part; and
a shielding part, the shielding part at least connecting to a side of the deflective part; and
a lower electrode, located substantially below the deflective part;
wherein the deflective part deforms by attraction to the lower electrode with a voltage supplied thereto, and a location of the upper electrode is changed thereby.

2. The display unit of the micro electro mechanical system of claim 1, wherein a material of the deflective part is high stress material.

3. The display unit of the micro electro mechanical system of claim 2, wherein a material of the shielding part identical to the material of the deflective part.

4. The display unit of the micro electro mechanical system of claim 2, wherein a material of the shielding part is different from the material of the deflective part.

5. The display unit of the micro electro mechanical system of claim 2, wherein a material of the shielding part is low stress material.

6. The display unit of the micro electro mechanical system of claim 1, further comprising a dielectric layer located between the upper electrode and the lower electrode to insulate the upper electrode and the lower electrode.

7. The display unit of the micro electro mechanical system of claim 1, wherein the substrate is a transparent substrate.

8. The display unit of the micro electro mechanical system of claim 7, further comprising a back light source located below the transparent substrate.

9. The display unit of the micro electro mechanical system of claim 8, wherein the change of the location of the upper electrode controls how much light from the back light source penetrates through the transparent substrate.

10. The display unit of the micro electro mechanical system of claim 7, further comprising a light-reflecting plate located below the transparent substrate.

11. The display unit of the micro electro mechanical system of claim 7, further comprising a light-absorbing plate located below the transparent substrate.

12. The display unit of the micro electro mechanical system of claim 11, wherein a light-reflecting layer is located on an upper surface of the upper electrode.

13. The display unit of the micro electro mechanical system of claim 1, wherein a material of the lower electrode is selected from the group consisting of metal, silicide, doped polysilicon and metal oxide.

14. The display unit of the micro electro mechanical system of claim 13, wherein the metal oxide is selected from the group consisting of indium-tin oxide, indium oxide and tin oxide.

15. The display unit of the micro electro mechanical system of claim 2, wherein the high stress material is selected from the group consisting of chromium, nickel, molybdenum, titanium and any arbitrary combination thereof.

16. The display unit of the micro electro mechanical system of claim 5, wherein the low stress material is selected from the group consisting of silver, aluminum, copper, molybdenum, silicon and any arbitrary combination thereof.

17. The display unit of the micro electro mechanical system of claim 1, further comprising a light-absorbing material formed on a lower surface of the upper electrode.

18. The display unit of the micro electro mechanical system of claim 17, wherein the light-absorbing material is resin or metal with a low reflectivity or metal oxide with a low reflectivity.

19. The display unit of the micro electro mechanical system of claim 1, wherein the substrate is a light-absorbing substrate.

20. The display unit of the micro electro mechanical system of claim 19, wherein a light-reflecting layer is located on an upper surface of the upper electrode.

21. The display unit of the micro electro mechanical system of claim 1, wherein the substrate is a light-reflecting substrate.

22. The display unit of the micro electro mechanical system of claim 19, wherein a light-absorbing layer is located on an upper surface of the upper electrode.

23. A planar display apparatus, the planar display apparatus comprising:
a transparent substrate, a plurality of transmissible display units being located thereon, each of the transmissible display units comprising:
an upper electrode, the upper electrode comprising:
a low stress structure; and
a high stress structure, the high stress structure at least connecting to a side of the low stress structure; and
a lower electrode, located substantially beneath the high stress structure; and
a back light source, located below the transparent substrate;
wherein the high stress structure is deformed due to attraction to the lower electrode with a voltage supplied thereto, and a location of the high stress structure is changed to control how much light from the back light source penetrates through the transparent substrate.

24. The planar display apparatus of claim 23, further comprising a color filter located on the transparent substrate.

25. The planar display apparatus of claim 23, further comprising a color filter located between the transparent substrate and the back light source, or the transparent substrate located between the color filter and the back light source.

26. The planar display apparatus of claim 23, further comprising a dielectric layer located between the upper electrode and the lower electrode to insulate the upper electrode and the lower electrode.

27. The planar display apparatus of claim 23, wherein a material of the lower electrode is selected from the group consisting of metal, silicide, doped polysilicon and metal oxide.

28. The planar display apparatus of claim 27, wherein the metal oxide is selected from the group consisting of indium-tin oxide, indium oxide and tin oxide.

29. The planar display apparatus of claim 23, wherein the high stress material is selected from the group consisting of chromium, nickel, molybdenum, titanium and any arbitrary combination thereof.

30. The planar display apparatus of claim 23, wherein the low stress material is selected from the group consisting of silver, aluminum, copper, molybdenum, silicon and any arbitrary combination thereof.

31. The planar display apparatus of claim 23, further comprising a light-absorbing material formed on a lower surface or an upper surface of the low stress structure.

32. The planar display apparatus of claim 31, wherein the light-absorbing material is resin or metal with a low reflectivity or metal oxide with a low reflectivity.

33. A planar display apparatus, the planar display apparatus comprising:
a transparent substrate, a plurality of transmissible display units being located thereon, each of the transmissible display units comprising:
an upper electrode, the upper electrode comprising:
a low stress structure, a light-absorbing layer thereof being located on an upper surface thereof; and
a high stress structure, the high stress structure at least connecting to a side of the low stress structure; and
a lower electrode, located substantially beneath the high stress structure; and
a light-reflecting plate, located below the transparent substrate;
wherein the high stress structure is deformed by attraction to the lower electrode with a voltage supplied thereto, and a location of the upper electrode is changed to control how much incident light is reflected by the light-reflecting plate.

34. The planar display apparatus of claim 33, further comprising a color filter located on the transparent substrate.

35. The planar display apparatus of claim 33, further comprising a dielectric layer located between the upper electrode and the lower electrode to insulate the upper electrode and the lower electrode.

36. The planar display apparatus of claim 33, wherein a material of the lower electrode is selected from the group consisting of metal, silicide, doped polysilicon and metal oxide.

37. The planar display apparatus of claim 36, wherein the metal oxide is selected from the group consisting of indium-tin oxide, indium oxide and tin oxide.

38. The planar display apparatus of claim 33, wherein the high stress material is selected from the group consisting of chromium, nickel, molybdenum, titanium and any arbitrary combination thereof.

39. The planar display apparatus of claim 33, wherein the low stress material is selected from the group consisting of silver, aluminum, copper, molybdenum, silicon and any arbitrary combination thereof.

40. The planar display apparatus of claim 33, further comprising a light-absorbing material formed on a lower surface of the low stress structure.

41. The planar display apparatus of claim 33, further comprising a light-absorbing material formed on the upper surface of the upper electrode.

42. The planar display apparatus of claim 33, wherein the light-absorbing material is resin or metal with a low reflectivity or metal oxide with a low reflectivity.

43. A planar display apparatus, the planar display apparatus, comprising:
a transparent substrate, on which a plurality of transmissible display units is located, each of the transmissible display units comprising:
an upper electrode, the upper electrode comprising:
a low stress structure, a light-reflecting layer thereof being located on an upper surface thereof; and
a high stress structure, the high stress structure connecting to a side of the low stress structure; and
a lower electrode, located substantially beneath the high stress structure; and
a light-absorbing plate, located below the transparent substrate;
wherein the high stress structure is deformed by attraction to the lower electrode with a voltage supplied thereto, and a location of the upper electrode is changed to control how much incident light is reflected by the light-reflecting layer.

44. The planar display apparatus of claim 43, further comprising a color filter located on the transparent substrate.

45. The planar display apparatus of claim 43, further comprising a dielectric layer located between the upper electrode and the lower electrode to insulate the upper electrode and the lower electrode.

46. The planar display apparatus of claim 43, wherein a material of the lower electrode is selected from the group consisting of metal, silicide, doped polysilicon and metal oxide.

47. The planar display apparatus of claim 46, wherein the metal oxide is selected from the group consisting of indium-tin oxide, indium oxide and tin oxide.

48. The planar display apparatus of claim 43, wherein the high stress material is selected from the group consisting of chromium, nickel, molybdenum, titanium and any arbitrary combination thereof.

49. The planar display apparatus of claim 43, wherein the low stress material is selected from the group consisting of silver, aluminum, copper, molybdenum, silicon and any arbitrary combination thereof.

50. The planar display apparatus of claim 43, wherein a light-reflecting layer is located on the upper surface of the upper electrode.
